(19) United States
(12) Patent Application Publication
(10) Pub. No.: US 2010/0313824 A1
(43) Pub. Date: Dec. 16, 2010

(54) Portable Pet Housing with Zip Out Structure

(76) Inventors: Melaney Northrop, Mansfield, TX (US); Adam W. Weber, Keller, TX (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/483,291

(22) Filed: Jun. 12, 2009

(51) Int. Cl. A01K 1/03; A01K 1/02

(52) U.S. Cl. 119/496; 119/500; 119/501; 119/498

(57) ABSTRACT

A portable pet housing for accommodating a pet includes a body including a bottom, a front wall and a rear wall. The front wall and rear wall are attached to the bottom. A sidewall extends between the front wall and the rear wall. The walls define an opening for the body opposite the bottom. The opening is covered by a top which is selectively attachable to the front wall and the rear wall. The top includes support structure for maintaining the front wall and the rear wall substantially perpendicular to the bottom when the top is attached to the front wall and the rear wall. When the top is removed from the front wall and the rear wall, the walls are foldable on top of the bottom wall.

### TECHNICAL FIELD OF THE INVENTION

The present invention relates portable pet housings, and more particularly to a portable pet housing having a zip out structure.

### BACKGROUND ART OF THE INVENTION

Numerous housings have been proposed for pets including, for example, shelters, kennels and carriers. Due to the mobility of pet owners, it is desirable to have pet housings available at different locations which requires a housing to be easily transportable and which requires a minimal amount of space. Portable pet housings are typically difficult to assemble, and may require tools in the assembly process.

A need has arisen for a portable pet housing that is easily assemblable and disassemblable and which can be stored in a small storage space for travel as well as to facilitate efficient sale and merchandising at the point of sale.

### SUMMARY OF THE INVENTION

In accordance with the present invention, a portable pet housing for accommodating a pet is provided. The housing includes a body including a bottom, a front wall and a rear wall. The front wall and rear wall are attached to the bottom. A sidewall extends between the front wall and the rear wall. The walls define an opening for the body opposite the bottom. The opening is covered by a top which is selectively attachable to the front wall and the rear wall. The top includes support structure for maintaining the front wall and the rear wall substantially perpendicular to the bottom when the top is attached to the front wall and the rear wall. When the top is removed from the front wall and the rear wall, the walls are foldable on top of the bottom wall.

### BRIEF DESCRIPTION OF THE DRAWINGS

For a more complete understanding of the present invention and for further advantages thereof, reference is now made to the following description taken in conjunction with the accompanying drawings in which:

FIG. 1 is a perspective view of the present portable pet housing with the top attached;

FIG. 2 is a perspective view of the present portable pet housing with the top removed;

FIG. 3 is a perspective view of the present pet housing top;

FIG. 4 is a perspective view of an alternate embodiment of the present pet housing top;

FIG. 5 is a side elevational view of the pet housing shown in FIG. 2;

FIG. 6 is a side elevational view of the pet housing shown in FIG. 5 in a partially collapsed position;

FIG. 7 is a side elevational view of the pet housing shown in FIG. 6 in a fully collapsed position;

FIG. 8 is a perspective view of an alternate embodiment of the present portable pet housing;

FIG. 9 is a perspective view of the portable pet housing shown in FIG. 1 with the door open;

FIG. 10 is an enlarged side elevational view of the pet housing shown in FIG. 9 illustrating the open door attachment device;

FIG. 11 is a side elevational view of the present zipper pull locking device;

FIG. 12 is a side elevational view of an alternate embodiment of the present zipper pull locking device;

FIG. 13 is a side elevational view of the present pet housing illustrating an alternate ventilation structure;

FIG. 14 is a perspective view of the present pet housing shown in FIG. 1 including fabric ventilation window and door covers;

FIG. 15 is a perspective view of an alternate embodiment of the present portable pet housing with support structure in a sidewall;

FIG. 16 is a perspective view of the pet housing shown in FIG. 1 with a foldable bottom;

FIG. 17 is a side elevational view of the pet housing shown in FIG. 16 in a partially collapsed position;

FIG. 18 is a side elevational view of the pet housing show in FIG. 17 in a fully collapsed position;

FIG. 19 is an exploded perspective view of an alternate embodiment of the present portable pet housing with sidewall supports;

FIG. 20 is a perspective view of an alternate embodiment of the present portable pet housing having a top support;

FIG. 21 is a top plan view of the pet housing top shown in FIG. 20 in a partially folded position;

FIG. 22 is a top plan view of the pet housing top shown in FIG. 21 in a further folded position;

FIG. 23 is a top plan view of the pet housing top shown in FIG. 22 in a fully folded position;

FIG. 24 is an exploded perspective view of an alternate embodiment of the present portable pet housing with removable front and rear walls; and

FIG. 25 is a side elevational view of the pet housing shown in FIG. 24 in a collapsed position.

### DESCRIPTION OF THE PREFERRED EMBODIMENT

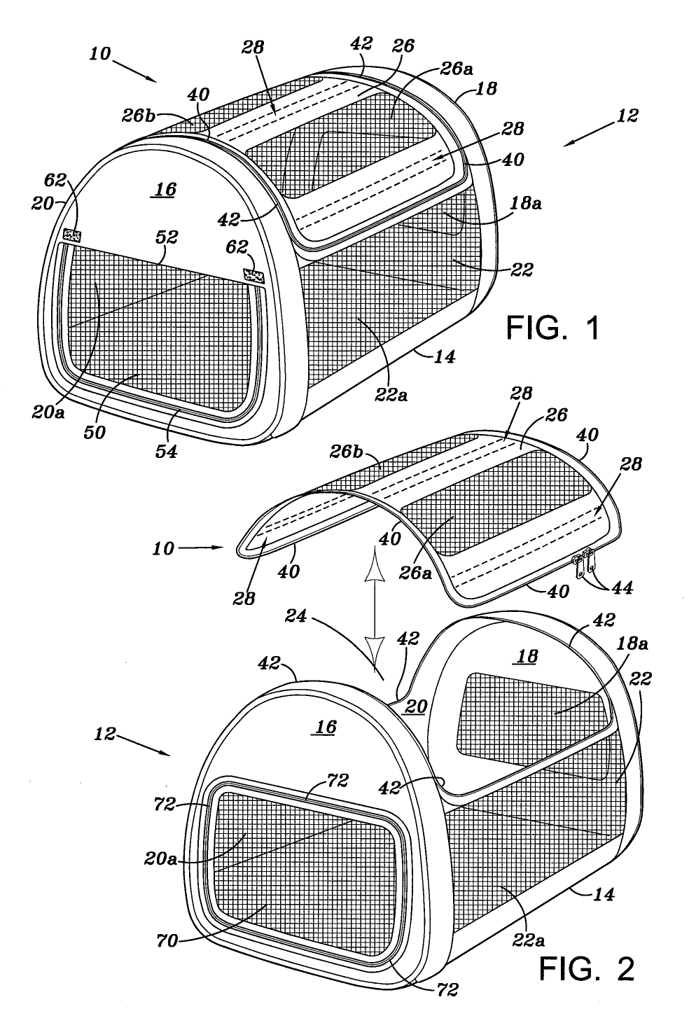

Referring simultaneously to FIGS. 1 and 2, the present portable pet housing is illustrated, and is generally identified by the numeral 10. Pet housing 10 includes a body, generally identified by the numeral 12. Body 12 includes a bottom 14, a front wall 16, a rear wall 18, a first side wall 20 and a second side wall 22. Front wall 16 and rear wall 18 are disposed generally perpendicular to bottom 14 in the assembled position of pet housing 10. First side wall 20 and second side wall 22 extend between front wall 16 and rear wall 18 of body 12 and are both permanently attached to front wall 16 and rear wall 18.

Wall 16, 18, 20 and 22 define an opening 24 (FIG. 2) opposite bottom 14 of body 12. Opening 24 may serve as a door for use by a pet owner to lift a pet in and out of body 12.

Opening 24 is selectively closed using a top 26. FIG. 1 illustrates top 26 secured to body 12 whereas FIG. 2 illustrates top 26 detached from body 12.

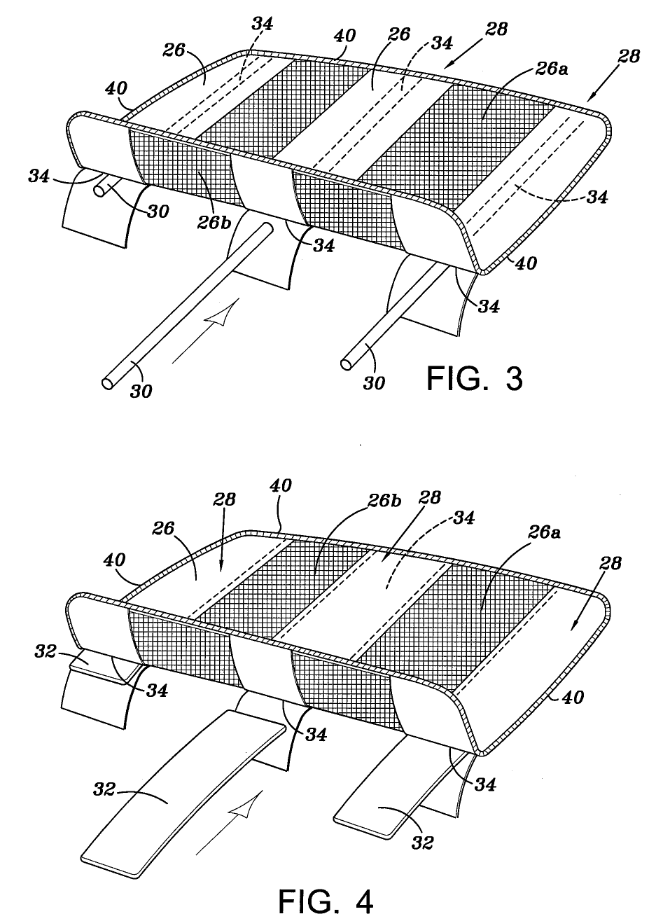

Top 26 includes support structure, generally identified by the numeral 28. As more clearly illustrated in FIGS. 3 and 4, support structure 28 includes a plurality of rods 30 or, alternatively, flat plates 32 which are insertable into pockets 34 contained within top 26. Rods 30 and flat plates 32 are shown for illustrative purposes only, and other similarly shaped support structure can be utilized with top 26. Rods 30 may be fabricated from, for example, fiberglass rods, extruded plastic tubing, such as PP, PVC and PE, and flexible wood. Plates 32 may be fabricated from, for example, fiberglass boards, extruded plastic corrugated, and solid die cut plastic, such as PP, PE and ABS. Pockets 34 may be completely secured after rods 30 or plates 32 have been inserted, or alternatively, one end can be left open. The use of supporting structure 28 maintains front wall 16 and rear wall 18 generally perpendicular to bottom 14 of body 12 when top 26 is secured to front wall 16 and rear wall 18 in the assembled position of pet housing 10.

Referring again to FIGS. 1 and 2, top 26 is selectively attachable to body 12 to close opening 24 utilizing a zipper 40. As shown in FIG. 2, zipper 40 extends along the entire circumference of top 26. Zipper 40 of top 26 is secured to a mating zipper 42 which extends along the top edges of walls 16, 18, 20 and 22. FIG. 1 illustrates zippers 40 and 42 engaged such that top 26 completely closes opening 24 of body 12. Zipper 42 includes zipper pulls 44.

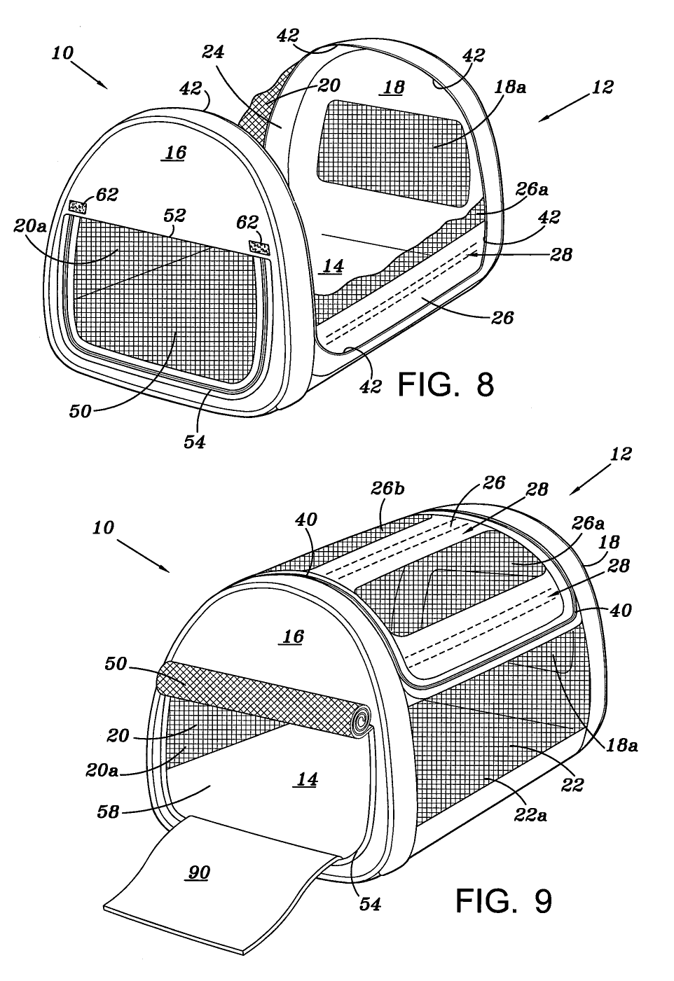

FIGS. 1 and 2 illustrate top 26 being completely detachable from body 12. As an alternative embodiment, one edge of top 26 may be permanently attached to a side wall 20 or 22 such that top 26 is not completely removable from body 12, but is selectively attachable to walls 16, 18 and one of walls 20 or 22. A further alternate embodiment of housing 10 where top 26 extend to bottom 14 is illustrated in FIG. 8.

One or more of walls 18, 20 and 22 and top 26 may include, for example, mesh fabric windows 18a, 20a, 22a, 26a and 26b, for providing ventilation for body 12.

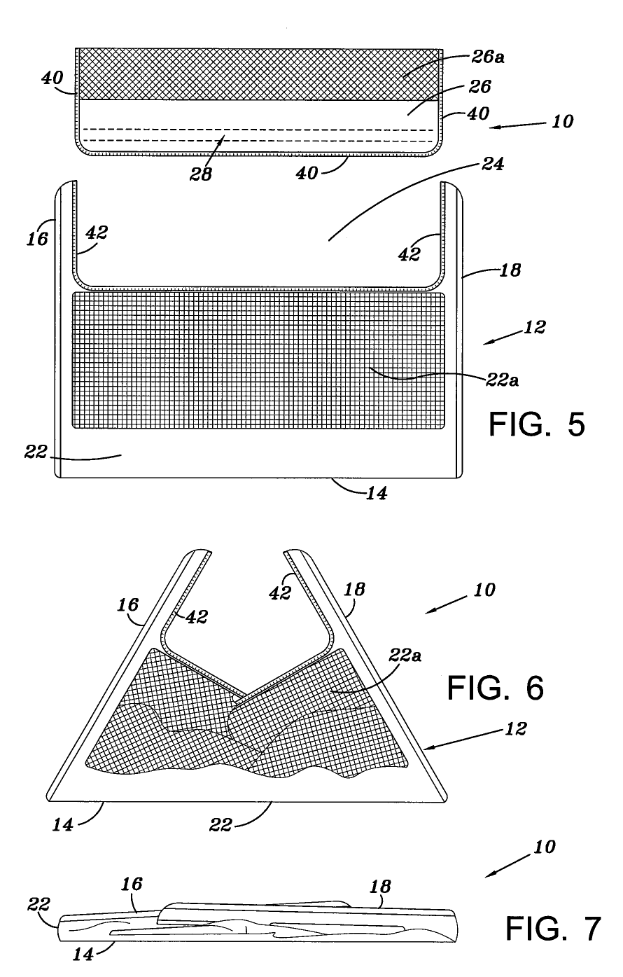

Referring to FIGS. 5, 6 and 7, portable pet housing 10 is foldable from the positions illustrated in FIGS. 1 and 2, to a collapsed position as illustrated in FIG. 7.

Top 26 is removed from body 12 (FIG. 5) which permits front wall 16 and rear wall 18 to collapse since support structure 28 has been removed with the removal of top 26. FIG. 6 illustrates front wall 16 and rear wall 18 partially collapsed and folded over bottom 14. FIG. 7 illustrates housing 10 in a fully collapsed and disassembled position wherein front wall 16 and rear wall 18 are folded flat over bottom 14 of body 12. In the folded position of housing 10, housing 10 is easily transportable for travel purposes as well as for efficient sale and merchandising at a retail point of sale. In the folded position of housing 10, top 26 is disposed on top of folded body 12.

Referring again to FIG. 1, body 12 of pet housing 10 includes a door 50 disposed in either or both of front walls 16 and rear wall 18. Door 50 includes a top edge 52 which is permanently secured to front wall 16 or rear wall 18 and includes a zipper 54 for selectively securing door 50 to body 12. Door 50 may include, for example, mesh fabric for providing additional ventilation for body 12.

FIG. 9 illustrates door 50 in an open position to open a doorway 58 for access to body 12 of pet housing 10. Door 50 is rolled towards edge 52 and is temporarily secured to front wall 16 using a hook 60 and loop 62 fastener as illustrated in FIG. 10. Other fasteners may be utilized, such as for example, an elastic cord over a button, a snap type closure, button hole and button, or magnetic type clasp for holding door 50 in the open position.

Referring again to FIG. 2, an additional embodiment of a door for body 12 as illustrated. Door 70 is disposed in either or both of front wall 16 or rear wall 18 and includes a zipper 72 around the full perimeter of door 70 to allow complete removability of door 70 from body 12.

While doors 50 and 70 have been illustrated as included within one or both of front wall 16 and rear wall 18, a door may also be provided in one or both of sidewalls 20 and 22 of body 12 of pet housing 10.

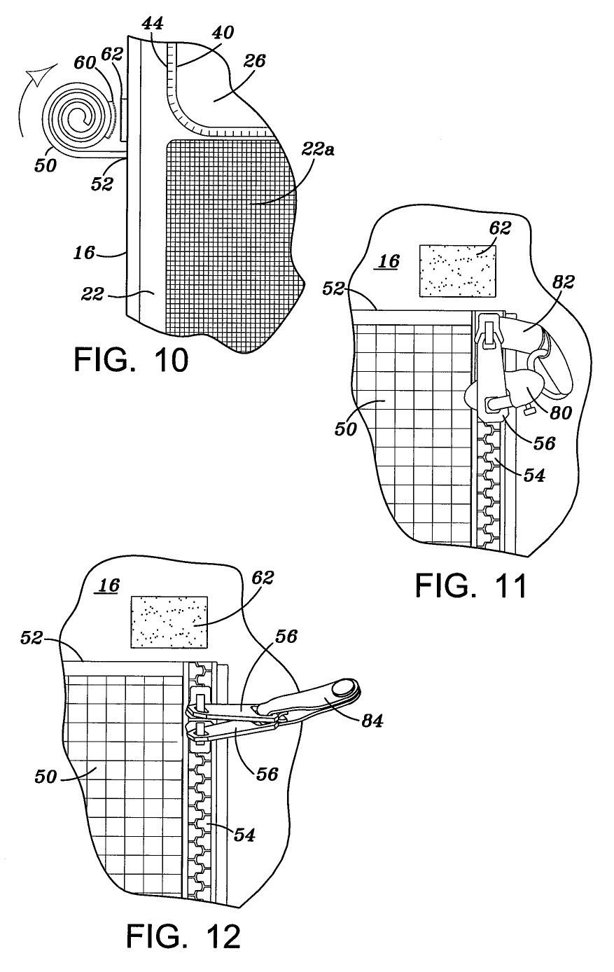

Referring now to FIGS. 11 and 12, while a pet is secured within body 12 of pet housing 10, it is important that the zippers associated with doors 50 and 70, are secured. FIG. 11 illustrates zipper 54 having zipper pull 56 which is secured utilizing a clasp 80, such as for example, a “lobster claw” clasp. Clasp 80 is secured to front wall 16 by a, for example, sewn loop 82, spring clasp or hook and loop fabric connector. FIG. 12 illustrates a snap connector 84 for securing zipper pulls 56.

Referring again to FIG. 9, pet housing 10 includes a door mat 90 which is secured to front wall 16 of body 10. Door mat 90 is utilized to maintain the inside of body 12 clean as well as to protect the flooring on which pet housing 10 is supported upon. Door mat 90 may be permanently secured to body 12 or detachable utilizing a zipper or hook and loop fabric attachment.

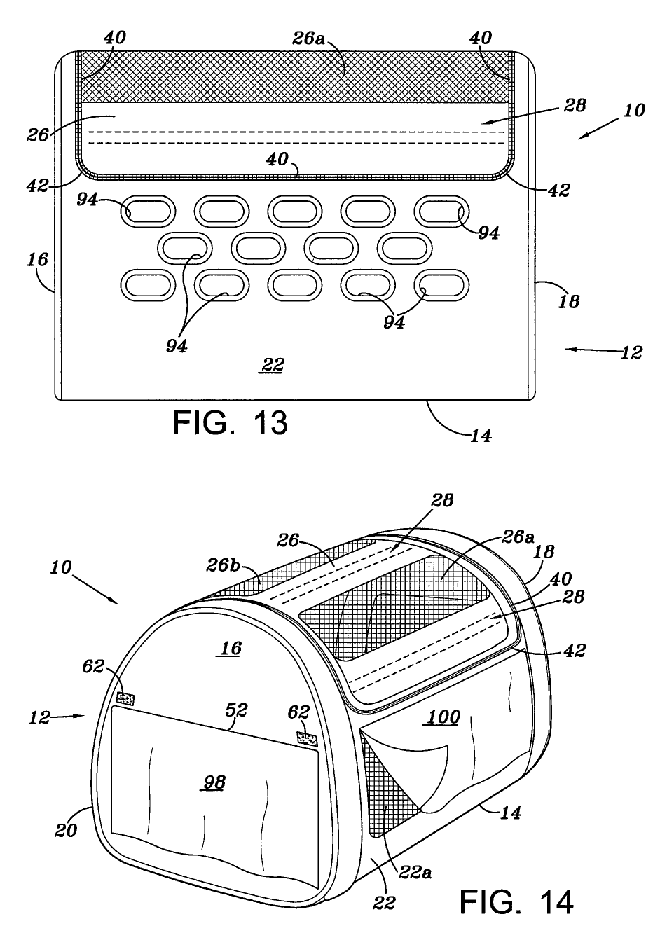

Referring to FIG. 13, an additional ventilation structure is illustrated for body 12, and includes apertures 94 positioned in either one or both of sidewalls 20 or 22.

FIG. 14 illustrates use of flaps 98 and 100 for controlling the amount of ventilation desired for pet housing 10. Flap 98 is utilized to cover a door within front wall 16. Flap 100 is utilized to cover window 22a of sidewall 22 of body 12.

Referring now to FIG. 15, a further embodiment of the present portable pet housing 10 is illustrated in which sidewall 22 includes support structure 28 instead of top 26. A similar sidewall 22 can be utilized with sidewall 20. Sidewall 22 including support structure 28 maintains front wall 16 and rear wall 18 generally perpendicular to bottom 14 of body 12 wherein sidewall 22 is secured to front wall 16 and rear wall 18. In the embodiment shown in FIG. 15, top 26 is integrally connected to front wall 16, rear wall 18, and side walls 20 and 22. Top 26 is entirely composed of window 26a.

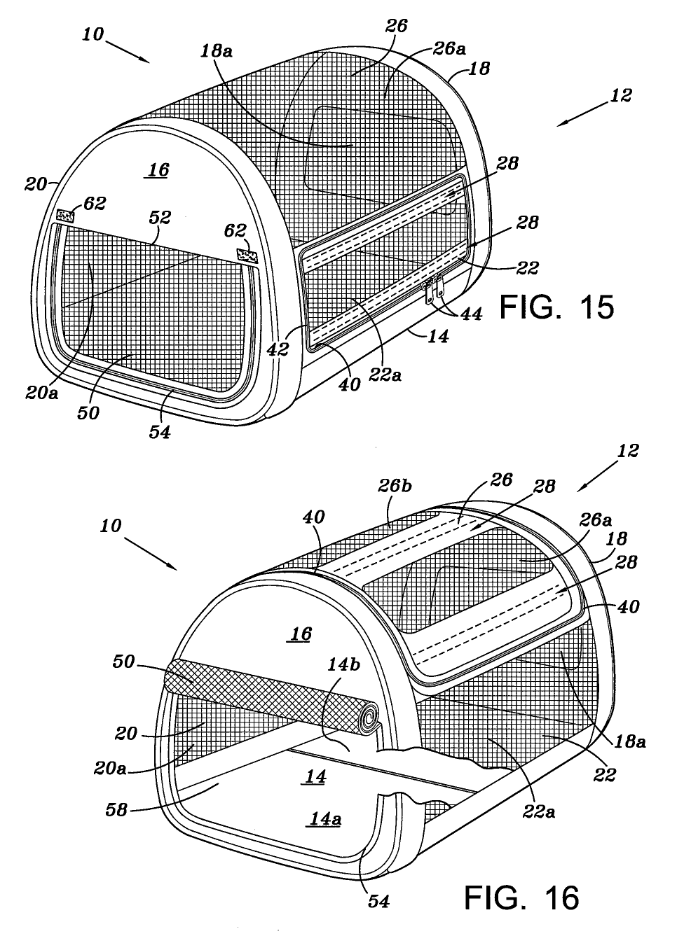

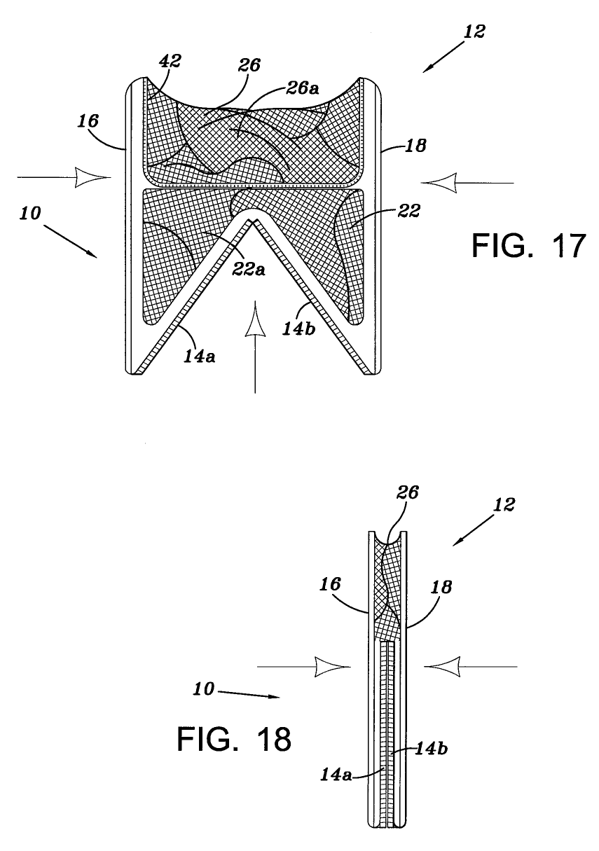

Referring now to FIG. 16, an alternate embodiment of bottom 14 is illustrated wherein bottom 14 includes foldable components 14a and 14b. Components 14a and 14b may be sewn into a foldable bottom 14 which may be fabric covered to form a pet bed. Use of foldable floor 14 allows pet housing 10 to fold as illustrated in FIGS. 17 and 18 where bottom 14 is folded between walls 16 and 18 in a folded position.

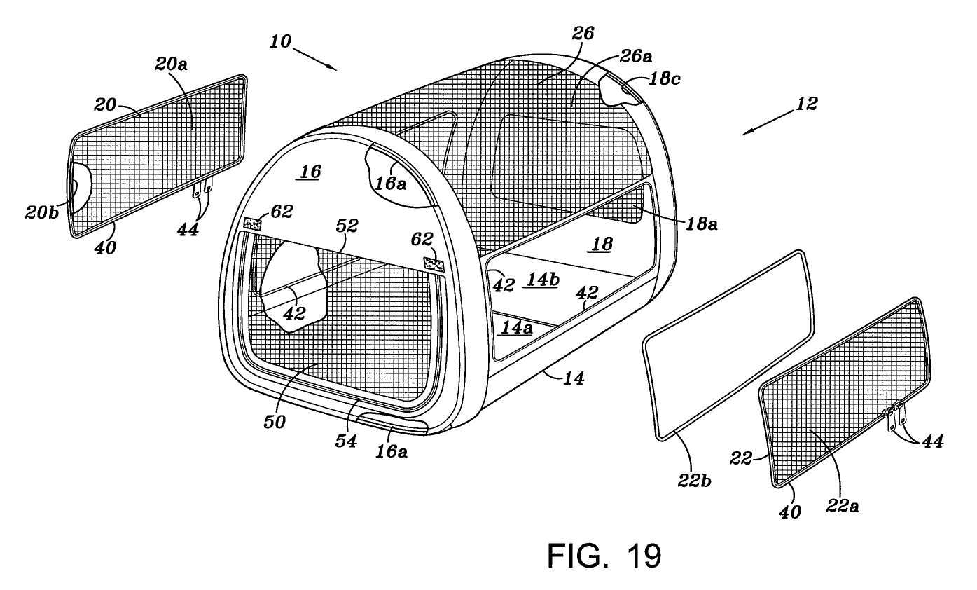

Referring to FIG. 19, a further embodiment of the present pet housing 10 is illustrated in which front wall 16, rear wall 18, first sidewall 20 and second sidewall 22 each include a support wire, 16a, 18c, 20b, and 22b, respectively, which provide support for each wall of body 12. First sidewall 20 and second sidewall 22 have a similar configuration to sidewall 22 of FIG. 15, but no support structure 28 is utilized. With the removal of sidewalls 20 and 22 from the pet housing 10 shown in FIG. 19, pet housing 10 folds as illustrated in FIGS. 17 and 18. The support wires 16a, 18c, 20b and 22b of pet housing 10 illustrated in FIG. 19, are integrally attached to their respective walls.

Referring now to FIG. 20, a further embodiment of the present pet housing 10 is illustrated which is similar to the pet housing 10 illustrated in FIG. 2 except for a top, generally identified by the number 102, which is utilized instead of top 26. Top 102 includes a wire support 110 disposed around the perimeter of top 102 which provides support for top 102 and maintains front wall 16 and rear wall 18 generally perpendicular to bottom 14 of body 12 wherein top 102 is secured to front wall 16 and rear wall 18 in the assembled position of pet housing 10 shown in FIG. 20.

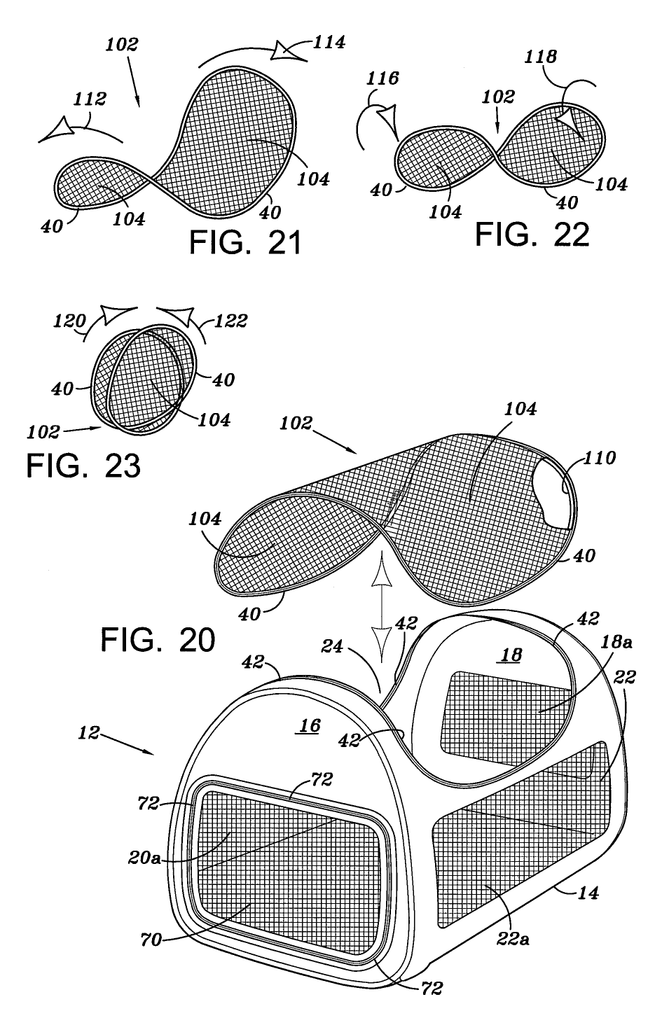

FIGS. 21, 22 and 23 illustrate the foldability of top 102 to generally form two concentric circles as shown in FIG. 23. Top 102 is first twisted in the direction of arrows 112 and 114 (FIG. 21), then twisted in the direction of arrows 116 and 118 (FIG. 22), and finally in the direction of arrows 120 and 122 (FIG. 23). Body 12 of pet housing 10 shown in FIG. 20 can be folded as illustrated in FIGS. 7 or 18.

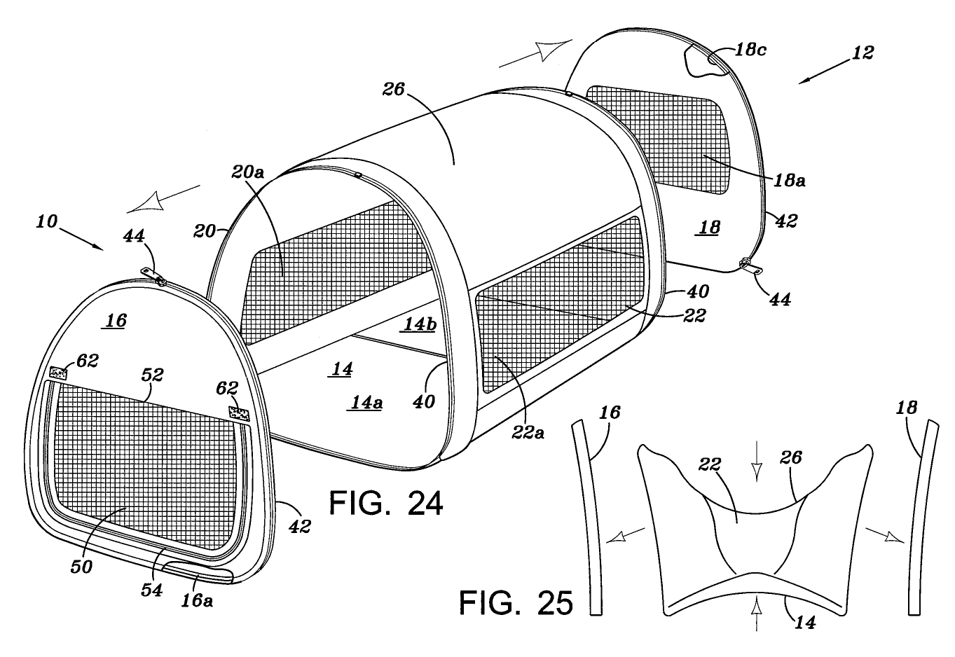

Referring to FIG. 24, a further embodiment of the present pet housing 10 is illustrated in which front wall 16 and rear wall 18 each include a support wire, 16a and 18c, respectively, and which are completely removable from body 12 using zippers 42 and 44. First sidewall 20 and second sidewall 22 have a similar configuration to sidewalls 20 and 22 of FIG. 2. With the removal of front wall 16 and rear wall 18 from the pet housing 10 shown in FIG. 24, pet housing 10 folds as illustrated in FIG. 25. The support wires 16a and 18c of pet housing 10 illustrated in FIG. 24, are integrally attached to their respective walls. Zipper pulls 44 may be secured using the structure illustrated in FIGS. 11 and 12.

We claim:

1. A portable pet housing for accommodating a pet, comprising:
a body including a bottom, a front wall attached to said bottom, a rear wall attached to said bottom and a sidewall extending between said front wall and said rear wall, said walls defining an opening for said body opposite said bottom;
a top for covering said opening, said top selectively attachable to said front wall and said rear wall; and
said top including support structure for maintaining said front wall and said rear wall substantially perpendicular to said bottom when said top is attached to said front wall and said rear wall.

2. The portable pet housing of claim 1 wherein said top is further selectively attachable to said side wall.

3. The portable pet housing of claim 1 wherein said side wall includes a first sidewall and a second sidewall extending between said front wall and said rear wall, and said top is further selectively attachable to said first sidewall and to said second sidewall and is completely removable from said body.

4. The portable pet housing of claim 1 wherein said top includes a pocket for receiving said support structure.

5. The portable pet housing of claim 4 wherein said support structure includes a rod disposed in said pocket.

6. The portable pet housing of claim 4 wherein said support structure includes a flat plate disposed in said pocket.

7. The portable pet housing of claim 1 wherein said front wall, said rear wall and said sidewall includes mesh fabric windows for providing ventilation for said body.

8. The portable pet housing of claim 7 wherein said sidewall window includes a cover.

9. The portable pet housing of claim 1 wherein said top includes a mesh fabric window for providing ventilation for said body.

10. The portable pet housing of claim 1 wherein said sidewall includes a plurality of apertures for providing ventilation for said body.

11. The portable pet housing of claim 1 wherein said front wall includes a door for said body.

12. The portable pet housing of claim 11 wherein said door includes a zipper for selective attachment to said front wall, such that said door is completely removable from said front wall.

13. The portable pet housing of claim 11 wherein said door includes a zipper for selective attachment to said front wall, said door having a top edge attached to said front wall to prevent removal of said door from said front wall.

14. The portable pet housing of claim 13 wherein said front wall includes attachment structure for maintaining said door in an open position.

15. The portable pet housing of claim 11 wherein said door includes a zipper for selective attachment to said front wall, said zipper including a zipper pull and structure for locking said pull to prevent opening of said zipper.

16. The portable pet housing of claim 11 and further including a cover for said door.

17. The portable pet housing of claim 1 wherein said top includes a zipper for selectively attaching said top to said body.

18. The portable pet housing of claim 1 where said front wall and said rear wall are foldable on top of said bottom when said top is disengaged from said front wall and said rear wall.

19. The portable pet housing of claim 1 wherein said bottom is foldable between said sidewalls when said top is disengaged from said front wall and said rear wall.

20. The portable pet housing of claim 1 wherein said top support structure includes a rod disposed around the perimeter of said top.

21. The portable pet housing of claim 1 and further including a mat extending from said front wall opposite said bottom.

22. A portable pet housing for accommodating a pet, comprising:
a body including a bottom, a front wall attached to said bottom, a rear wall attached to said bottom, a first sidewall extending between said front wall and said rear wall, a second sidewall spaced apart from said first sidewall and extending between said front wall and said rear wall, said walls defining an opening for said body opposite said bottom;
a top for covering said opening, said top attached to said walls; and
said first sidewall including support structure for maintaining said front wall and said rear wall substantially perpendicular to said bottom.

23. The portable pet housing of claim 22 wherein said first sidewall is selectively attachable to said front wall, said rear wall, said top and said bottom.

24. The portable pet housing of claim 22 wherein said first sidewall includes a pocket for receiving said support structure.

25. The portable pet housing of claim 24 wherein said support structure includes a rod disposed in said pocket.

26. The portable pet housing of claim 25 wherein said support structure includes a flat plate disposed in said pocket.

27. The portable pet housing of claim 21 wherein said first sidewall support structure includes a rod disposal around the perimeter of said first sidewall.

28. The portable pet housing of claim 22 wherein said first sidewall includes a zipper for selectively attaching said first sidewall to said body.

29. The portable pet housing of claim 22 where said front wall and said rear wall are foldable on top of said bottom when said first sidewall is disengaged from said front wall and said rear wall.

30. The portable pet housing of claim 22 wherein said bottom is foldable between said sidewalls when said first sidewall is disengaged from said front wall and said rear wall.

31. A portable pet housing for accommodating a pet, comprising:
a body including a bottom, a front wall, a rear wall, a first sidewall extending between said front wall and said rear wall, a second sidewall spaced apart from said first sidewall and extending between said front wall and said rear wall, said walls defining an opening for said body opposite said bottom;
a top for covering said opening, said top attached to said walls; and
said front wall and said rear wall including support structure for maintaining said front wall and said rear wall substantially perpendicular to said bottom and being selectively attachable to said first sidewall, said second sidewall, said top and said bottom.

32. The portable pet housing of claim 31 wherein said support structure includes a rod disposal around the perimeter of said front wall and said rear wall.

33. The portable pet housing of claim 31 wherein said front wall and said rear wall each includes a zipper for selective attachment to said sidewalls, said top and said bottom.

34. The portable pet housing of claim 31 wherein said bottom is foldable between said sidewalls when said sidewalls are disengaged from said front wall and said rear wall.

35. A portable pet housing for accommodating a pet, comprising:
a body including a bottom wall, a front wall, a rear wall, a first sidewall extending between said front wall and said rear wall, a second sidewall spaced apart from said first sidewall and extending between said front wall and said rear wall, and a top wall disposed opposite said bottom wall; and
at least one of said walls including support structure for supporting said body and being completely detachable from said body.

36. The portable pet housing of claim 35 wherein said front wall and said rear wall each include a zipper for selective attachment of said front wall and said rear wall to said sidewalls, said top wall and said bottom wall.

37. The portable pet housing of claim 35 wherein said top wall includes a zipper for selective attachment of said top wall to said front wall, said rear wall and said sidewalls.

38. The portable pet housing of claim 35 wherein at least one of said sidewalls includes a zipper for selective attachment of a sidewall to said top wall, said bottom wall, said front wall and said rear wall.

39. The portable pet housing of claim 35 wherein said support structure includes a rod disposed around the perimeter of a wall.

40. The portable pet housing of claim 35 wherein said support structure includes a rod disposed centrally between ends of a wall.
